(19) United States
(12) Patent Application Publication
(10) Pub. No.: US 2025/0219982 A1
(43) Pub. Date: Jul. 3, 2025

(54) APPARATUS AND METHOD FOR ALTERNATE CHANNEL COMMUNICATION INITIATED THROUGH A COMMON MESSAGE THREAD

(71) Applicant: Snap Inc., Santa Monica, CA (US)

(72) Inventors: Evan Spiegel, Los Angeles, CA (US); Robert Cornelius Murphy, Venice, CA (US); Chamal Samaranayake, Venice, CA (US)

(21) Appl. No.: 19/086,446

(22) Filed: Mar. 21, 2025

Related U.S. Application Data
(63) Continuation of application No. 17/937,777, filed on Oct. 3, 2022, now Pat. No. 12,284,152.
Application No. 17/937,777 is a continuation of application No. 17/193,667, filed on Mar. 5, 2021, now Pat. No. 11,463,393.
Application No. 17/193,667 is a continuation of application No. 16/059,834, filed on Aug. 9, 2018, now Pat. No. 10,949,049.
Application No. 16/059,834 is a continuation of application No. 14/510,051, filed on Oct. 8, 2014, now Pat. No. 10,082,926.
Application No. 14/510,051 is a continuation-in-part of application No. 14/187,005, filed on Feb. 21, 2014, now abandoned.

(51) Int. Cl. H04L 51/216; G06F 3/01; G06F 3/0481; G06F 3/04895; H04L 51/046; H04L 51/10

(52) U.S. Cl. CPC H04L 51/216; G06F 3/017; G06F 3/0481; G06F 3/04895; H04L 51/046; H04L 51/10

(57) ABSTRACT

A server has a processor and a memory storing a multiple channel message thread module with instructions executed by the processor to identify when participants at client devices are actively viewing a common message thread at the same time to establish a participant viewing state. An alternate channel communication lock prompt is supplied to the client devices in response to the participant viewing state. An alternate channel communication is delivered to the client devices in response to activation of the alternate channel communication lock prompt by at least one participant.

### CROSS-REFERENCE TO RELATED APPLICATION

This application is a continuation-in-part of U.S. Ser. No. 14/187,005, filed Feb. 21, 2014.

### FIELD OF THE INVENTION

This invention relates generally to communications in computer networks. More particularly, this invention relates to techniques for initiating an additional communication channel from a common text message communication channel.

### BACKGROUND OF THE INVENTION

Currently, when a first individual desires to initiate a telephone call or video call with a second individual the first individual uses his or her communication equipment to initiate a ringtone at the communication equipment of the second individual. Acknowledgement of the ringtone is required to establish the presence of the second individual. The ring tone notification technique has been relied upon since the inception of telephones, well over one hundred years ago. It would be desirable to find an alternate methodology to establish the presence of an individual and to initiate conversations, without reliance upon a technique over one hundred years old that is a relic of the technical constraints of analog telephony.

### SUMMARY OF THE INVENTION

A server has a processor and a memory storing a multiple channel message thread module with instructions executed by the processor to identify when participants at client devices are actively viewing a common message thread at the same time to establish a participant viewing state. An alternate channel communication lock prompt is supplied to the client devices in response to the participant viewing state. An alternate channel communication is delivered to the client devices in response to activation of the alternate channel communication lock prompt by at least one participant.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates user interface attributes associated with an embodiment of the invention.

FIG. 4 illustrates user interface attributes, including an alternate channel communication indicator, associated with an embodiment of the invention.

FIG. 5 illustrates an alternate user interface utilized in accordance with an embodiment of the invention.

Like reference numerals refer to corresponding parts throughout the several views of the drawings.

### DETAILED DESCRIPTION OF THE INVENTION

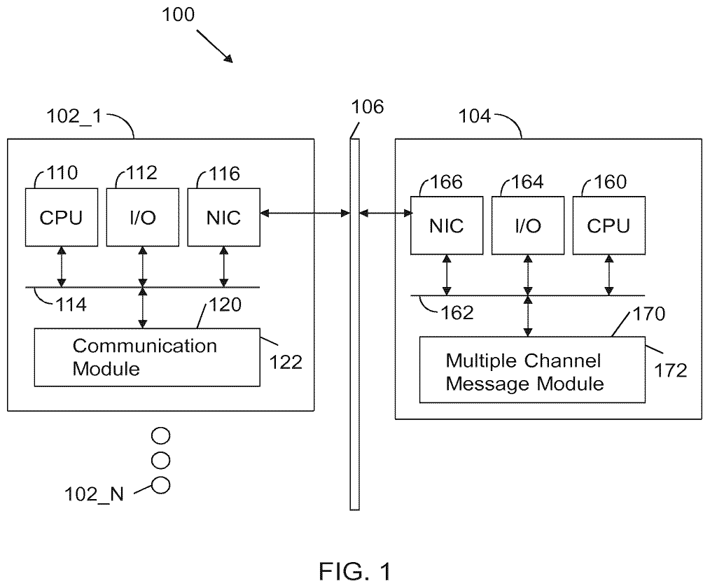

FIG. 1 illustrates a system 100 configured in accordance with an embodiment of the invention. The system 100 includes a set of client devices 102_1 through 102_N connected to a server 104 via a network 106, which may be any combination of wired and wireless networks.

Each client device 102 includes standard components, such as a central processing unit 110 and input/output devices 112 connected via a bus 114. The input/output devices 112 may include a touch display, keyboard, trackball and the like. A network interface circuit 116 is also connected to the bus 114 to provide connectivity to network 106. A memory 120 is also connected to the bus 114. The memory 120 stores a communication module 122, which may be a browser or an application to support communications with server 104. The client device 102 is typically a mobile device, such as a Smartphone or Tablet.

Server 104 also includes standard components, such as a central processing unit 160, a bus 162, input/output devices 164 and a network interface circuit 166. A memory 170 is also connected to the bus 162. The memory 170 stores a multiple channel message module 172, which includes executable instructions to implement operations of the invention. In short, the executable instructions identify the common presence of participants in a text based thread. In response, to such common presence, participants are afforded the opportunity to initiate an alternate communication channel, such as an audio channel or voice channel without the prerequisite of a ringtone.

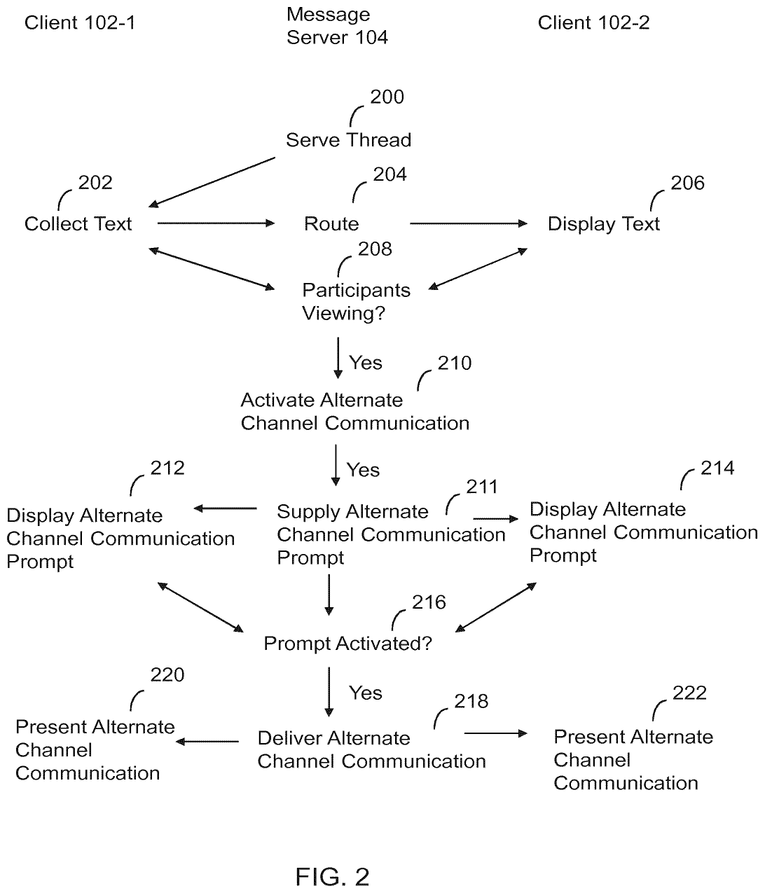

FIG. 2 illustrates operations associated with an embodiment of the invention. In particular, the figure illustrates operations performed by two client devices 102_1 and 102_2, as coordinated by the message server 104. Initially, the message server 104 serves a thread 200. By way of example, the thread is a text communication sequence between a first participant associated with client 102_1 and a second participant associated with client 102_2. Additional participants may be involved, but are omitted for simplicity of presentation.

The client device 102_1 collects a new text entry 202, which is routed by the message server 104 to client 102_2. The client 102_2 displays the text 206. The message server 104 determines if the participants are viewing the same thread 208. That is, the message server 104 evaluates whether each client device is actively displaying the same thread on the display of the client device. If so, the message server proactively activates an alternate channel communication 210. This can be thought of as a digital call set-up, where the telephone call is muted but active. The server also supplies each device with an alternate channel communication prompt 211. The alternate channel communication prompt is displayed 212 on client 102_1 and is displayed 214 on client 102_2. The alternate channel communication prompt signals to the participants that the message thread is being actively viewed by each participant,

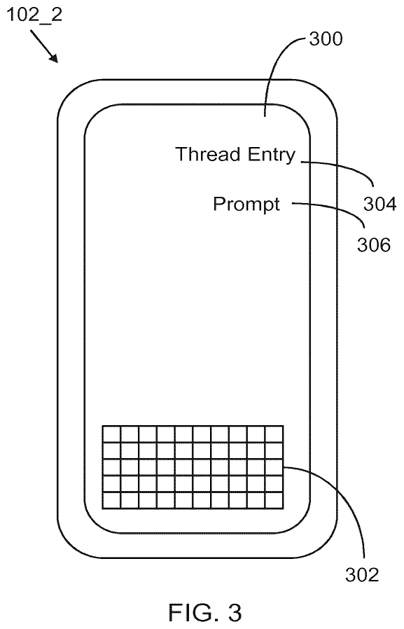

FIG. 3 illustrates client device 102_2 with a display 300 and keyboard 302. The display shows a thread entry 304 and an associated prompt 306 indicating common viewing of the thread. The prompt 306 may be in the form of text, an icon, an image and the like.

Returning to FIG. 2, the message server 104 determines whether the prompt is activated 216. For example, activation may be in the form of haptic contact by the participant on the prompt as displayed on a screen. If a prompt is activated, then the message server 104 delivers (e.g., un-mutes the set up call) the alternate channel communication 218. The alternate channel communication may be presented 220 on client 102_1 and/or be presented 222 on client 102_2. The processing of FIG. 2 is advantageous because of the proactive activation of the alternate channel communication before a prompt is activated. An alternate embodiment may activate the alternate channel communication in response to prompt activation.

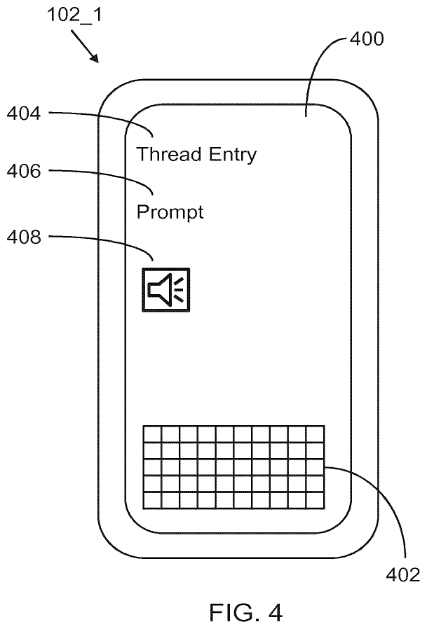

FIG. 4 illustrates client 102_1 with a display 400 and keyboard 402. The display 400 has a thread entry 404, a prompt 406 and an alternate channel indicator 408. In this example, the alternate channel indicator 408 may be a speaker indicative of an audio channel being initiated by the participant using client device 102_2. The alternate channel indicator 408 may be a block of video initiated by the participant using client device 102_2. In the example of FIG. 4, the message thread is shown with the alternate channel indicator. Alternately, the alternate channel indicator may occupy the entire display, which would be desirable in the case of a video session.

In one embodiment, the alternate channel communication persists during haptic contact with the alternate channel communication prompt by at least one participant. The alternate channel communication may include input from each participant making haptic contact with the alternate channel communication prompt.

The alternate channel communication may be a unidirectional audio session initiated through haptic content of a prompt by a first participant that is broadcast to the remaining participants. The alternate channel communication may be a bidirectional audio session between participants making haptic contact with the alternate channel communication prompt.

The alternate channel communication may be a unidirectional video session initiated through haptic contact of a prompt by a first participant that is broadcast to the remaining participants. The alternate channel communication may be a bidirectional video session between participants making haptic contact with the alternate channel communication prompt.

The prompt may include channel selection options, such as audio and/or video. The alternate channel communications may be coordinated through the message server using Internet Protocol packet switching techniques.

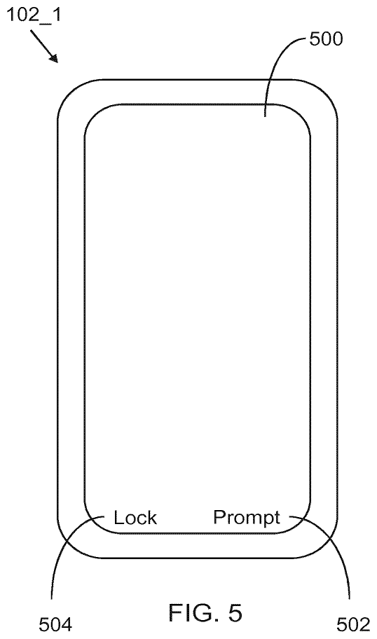

FIG. 5 illustrates a client device 102_1 with an alternate user interface on display 500. In this instance a prompt 502 for an alternate channel communication is accompanied by a lock prompt 504. The lock prompt 504 may be text or other indicia (e.g., a lock symbol) of an available lock state. Haptic engagement with the prompt 502 initiates the alternate channel communication. The user may then use a haptic gesture to engage the lock prompt 504. For example, a slide gesture from the prompt position 502 to the lock position 504 may be used. Alternately, the lock prompt 504 may be tapped. Alternately, prompt 502 may be eliminated, in which case, a permanent alternate channel communication state may be invoked by haptic contact with the lock prompt 504. The alternate channel communication state may be terminated through additional haptic contact with the lock prompt 504.

Once the lock prompt is engaged, haptic engagement with the prompt 502 is no longer necessary. Consider the case of an alternate channel communication in the form of a video, haptic engagement with the prompt 502 followed by haptic engagement with the lock 504 results in video being persistently displayed on the display 500. The video session may be terminated by haptic contact with the lock prompt 504. During the video session the display 500 may receive gestures to control whether a front-facing camera or a back-facing camera is utilized. For example, a double tap on the display 500 may toggle between the front-facing camera and the back-facing camera. Alternately, haptic contact with one section of the display 500 may invoke the front-facing camera, while haptic contact with another section of the display 500 may invoke the back-facing camera. For example, a left-to-right, gesture applied to the display 500 may toggle the front-facing camera to the back-facing camera, while a right-to-left gesture applied to the display 500 may toggle the back-facing camera to the front-facing camera. Other possibilities include swiping from bottom-to-top (or vice versa) or from one portion of the display to another (e.g., from one area to a section outside of the area, from bottom to top, etc.).

Another feature contemplated by embodiments of the invention include the utilization of a multifunctional prompt. For example, prompt 502 may be utilized for multiple functions in addition to activation of the alternate channel. In one embodiment, prompt 502 may be utilizable to ‘send’ a text message or activate a camera, etc. During situations where participants are viewing the same thread, prompt 502 may be altered to allow use for other purposes (e.g., to activate an alternate channel). In one example, prompt 502 may normally appear as a first color and turn a second color when it is available for alternate functions.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A system, comprising:
at least one processor; and
at least one memory component storing instructions that, when executed by the at least one processor, cause the at least one processor to perform operations comprising:
identifying when a first participant at a first client device and a second participant at a second client device are actively viewing a common message thread, comprising a thread entry, at a same time;
providing, in response to the identifying and without input from the first or second participants, for an alternate channel communication prompt and a lock prompt to be displayed together with the thread entry on the first client device,
wherein the alternate channel communication prompt is user-selectable for alternate channel communication between the first and second client devices, and
wherein the lock prompt is user-selectable for setting the alternate channel communication to a locked state;
receiving, from the first client device, an indication of user selection of both the alternate channel communication prompt and the lock prompt by the first participant; and
providing, in response to receiving the indication, for the alternate channel communication between the first and second client devices in the locked state.

2. The system of claim 1, the instructions further comprising:
providing for an alternate channel communication indicator to be displayed on the second client device, the alternate channel communication indicator being displayed together with the alternate channel communication lock prompt and the thread entry, wherein the alternate channel communication indicator is separate from the alternate channel communication prompt,
wherein the alternate channel communication indicator comprises a speaker icon when the alternate channel communication is audio-based, and
wherein alternate channel communication indicator comprises a video icon when the alternate channel communication is video-based.

3. The system of claim 1, the instructions further comprising:
toggling between a front-facing camera and a back-facing camera in response to a gesture applied to a display of a client device.

4. The system of claim 3, wherein the gesture is a tap to the display of the client device.

5. The system of claim 3, wherein the gesture is haptic contact with a designated area of the display of the client device.

6. The system of claim 3, wherein the gesture is a lateral gesture across the display of the client device.

7. The system of claim 1, wherein the alternate channel communication prompt is a multifunctional button capable of providing a function other than activation of the alternate channel communication.

8. The system of claim 1, wherein the alternate channel communication is a broadcast audio session from the first participant to the second participant.

9. The system of claim 1, wherein the alternate channel communication is a bidirectional audio session between the first and second participants.

10. The system of claim 1, wherein the alternate channel communication is a broadcast video session from the first participant to the second participant.

11. The system of claim 1, wherein the alternate channel communication is a bidirectional video session between the first and second participants.

12. A method, comprising:
identifying when a first participant at a first client device and a second participant at a second client device are actively viewing a common message thread, comprising a thread entry, at a same time;
providing, in response to the identifying and without input from the first or second participants, for an alternate channel communication prompt and a lock prompt to be displayed together with the thread entry on the first client device,
wherein the alternate channel communication prompt is user-selectable for alternate channel communication between the first and second client devices, and
wherein the lock prompt is user-selectable for setting the alternate channel communication to a locked state;
receiving, from the first client device, an indication of user selection of both the alternate channel communication prompt and the lock prompt by the first participant; and
providing, in response to receiving the indication, for the alternate channel communication between the first and second client devices in the locked state.

13. The method of claim 12, further comprising:
providing for an alternate channel communication indicator to be displayed on the second client device, the alternate channel communication indicator being displayed together with the alternate channel communication lock prompt and the thread entry,
wherein the alternate channel communication indicator is separate from the alternate channel communication prompt,
wherein the alternate channel communication indicator comprises a speaker icon when the alternate channel communication is audio-based, and
wherein alternate channel communication indicator comprises a video icon when the alternate channel communication is video-based.

14. The method of claim 12, further comprising:
toggling between a front-facing camera and a back-facing camera in response to a gesture applied to a display of a client device.

15. The method of claim 14, wherein the gesture is a tap to the display of the client device.

16. The method of claim 14, wherein the gesture is haptic contact with a designated area of the display of the client device.

17. The method of claim 12, wherein the alternate channel communication is a broadcast audio session from the first participant to the second participant.

18. The method of claim 12, wherein the alternate channel communication is a bidirectional audio session between the first and second participants.

19. The method of claim 12, wherein the alternate channel communication is a broadcast video session from the first participant to the second participant.

20. A non-transitory computer-readable storage medium storing instructions that, when executed by at least one processor, cause the at least one processor to perform operations comprising;
identifying when a first participant at a first client device and a second participant at a second client device are actively viewing a common message thread, comprising a thread entry, at a same time;
providing, in response to the identifying and without input from the first or second participants, for an alternate channel communication prompt and a lock prompt to be displayed together with the thread entry on the first client device,
wherein the alternate channel communication prompt is user-selectable for alternate channel communication between the first and second client devices, and
wherein the lock prompt is user-selectable for setting the alternate channel communication to a locked state;
receiving, from the first client device, an indication of user selection of both the alternate channel communication prompt and the lock prompt by the first participant; and
providing, in response to receiving the indication, for the alternate channel communication between the first and second client devices in the locked state.
